(19) United States
(12) Patent Application Publication
(10) Pub. No.: US 2005/0194809 A1
(43) Pub. Date: Sep. 8, 2005

(54) Split and/or folded safety visors for vehicles

(76) Inventor: Raquib Uddin Khan, Pleasanton, CA (US)

Correspondence Address: RAQUIB UDDIN KHAN, 5611 STONECLIFF VISTA LANE, PLEASANTON, CA, 94566, US

(21) Appl. No.: 11/020,364

(22) Filed: Dec. 23, 2004

Related U.S. Application Data
(60) Provisional application No. 60/550,002, filed on Mar. 5, 2004.

(51) Int. Cl. B60J 3/00

(52) U.S. Cl. 296/97.8

(57) ABSTRACT

A split and/or folded safety visor and method is provided for the vehicles where there is at least one driver and/or passenger is involved. The present invention provides, in an embodiment, a type of visor and method that ensures no use of hands to block the sun lights, headlight beams or similar while driving on a continuously changing direction as well as in straight path thus providing enormous safety of the driver and passengers. In an embodiment, the system and method can be employed in any automobile with a driver seat and/or in combination with passenger seats. A split or multi split visors can be used in the driver side as well as in the passenger side area. The split visors will allow the driver and or/passenger to fix the segments of the split visor in certain direction from the very beginning of the driving and sit comfortably even while changing the direction frequently. The split visor can be adjusted by opening the segments thus starting from 0 degree to 180 degree even though in most cases a 120 degree opening should be sufficient to block any unwanted light beam from any angles. The system described can be a integral part of the automobile during it's manufacture. In another embodiment, the split visors can be just a clip on system with the existing visors in vehicles and automobiles. Other features and advantages of this invention will be apparent to a person of skill in the art who studies the description of the invention.

This application claims priority from U.S. provisional application Ser. No. 60/550,002 filed on Mar. 5, 2004.

### FIELD OF THE INVENTION

The invention relates generally to any vehicles which transport man and/or materials from one destination to others with at least one driver, and more particularly to present day automobiles including basic models to ultra luxury models and/or sporty vehicles.

### BACKGROUND OF THE INVENTION

All kinds of vehicles including automobiles which are not remotely operated, use visors to protect or block the direct light effect either from sun light and/or from other approaching vehicles which provides driver and passengers safety as well as comfort while driving. Visors are very much needed specially when the sun light approaches to a very critical angle to the eyes of the driver and may give blind feelings while driving if the visor is not used properly in the proper direction. Visor also protects the drivers and passengers in the car by deflecting the heat wave thus giving comfort. The present day visors may also contain vanity mirrors or CD holders etc. for convenience. The present visors are mostly attached with thin rod which can rotate approximately 90 degree or more around a vertical axis thus covering the driver and or passenger while changing the direction. The visor can also rotate up or down (within rod) thus rotating around a horizontal axis reaching maximum position either touching the roof area or windshield/glass door area.

The present visor gives reasonable protection while driving in the straight road. But while changing the direction during driving, the incidence angle of the on coming light changes but the visor doesn't change the position. It's a common practice for the driver and/or passenger to adjust the visor by hand while driving either manually or by a knob/switch for power driven visor. It's known for a long time that many many accidents including fatality are responsible while changing the visor direction to adjust the incoming incident light. This phenomenon becomes very dangerous while driving in a mountain or hilly roads where changing direction is very frequent and a slight change in concentration may lead to fatal accident. This situation becomes even more pronounced when it's a combination of spiral and or slippery road. Thus what is needed is a method or suitable system/components which provide a safety driving condition when the adjustment of visor is needed.

### SUMMARY OF THE INVENTION

A split and/or folded safety visor and method is provided for the vehicles where there is at least one driver and/or passenger is involved. The present invention provides, in an embodiment, a type of visor and method that ensures no use of hands to block the sun lights, headlight beams or similar while driving on a continuously changing direction as well as in straight path thus providing enormous safety of the driver and passengers.

In an embodiment, the system and method can be employed in any automobile with a driver seat and/or in combination with passenger seats. A split or multi split visors can be used in the driver side as well as in the passenger side area including front and rear area of the vehicle. The split visors will allow the driver and or/passenger to fix the segments of the split visor in certain direction from the very beginning of the driving and sit comfortably even while changing the direction frequently. The split visor can be adjusted by opening the segments thus starting from 0 degree to 120 degree or more even though in most cases a 90 degree opening should be sufficient to block any unwanted light beam from any angles. The system described can be a integral part of the automobile during it's manufacture.

In another embodiment, the split visors can be just a clip on system with the existing visors in vehicles and automobiles.

Other features and advantages of this invention will be apparent to a person of skill in the art who studies the description of the invention.

### BRIEF DESCRIPTION OF THE INVENTION

The foregoing aspects and many of the advantages of this invention will become more readily appreciated by reference to the following detailed description, when taken in conjunction with the accompanying drawings. It's to be noted, however, that the appended drawings illustrate only typical embodiments of this invention and are therefore not to be considered limiting of its scope, for the invention may admit to other similar effective embodiments.

FIG. 1 is a typical visor in an automobile in which the present invention is useful

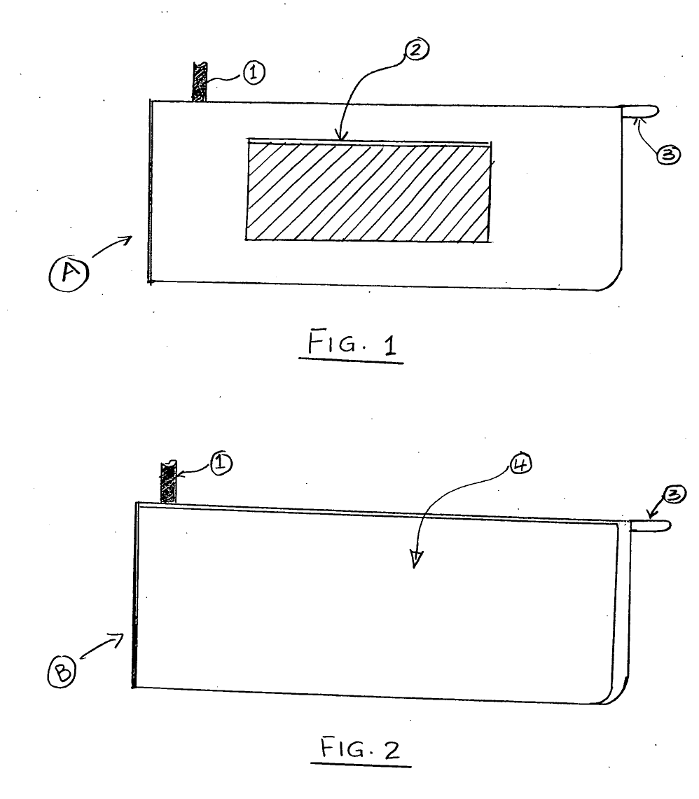

FIG. 2 is simplified view of the split visor shows the advantage of the present invention

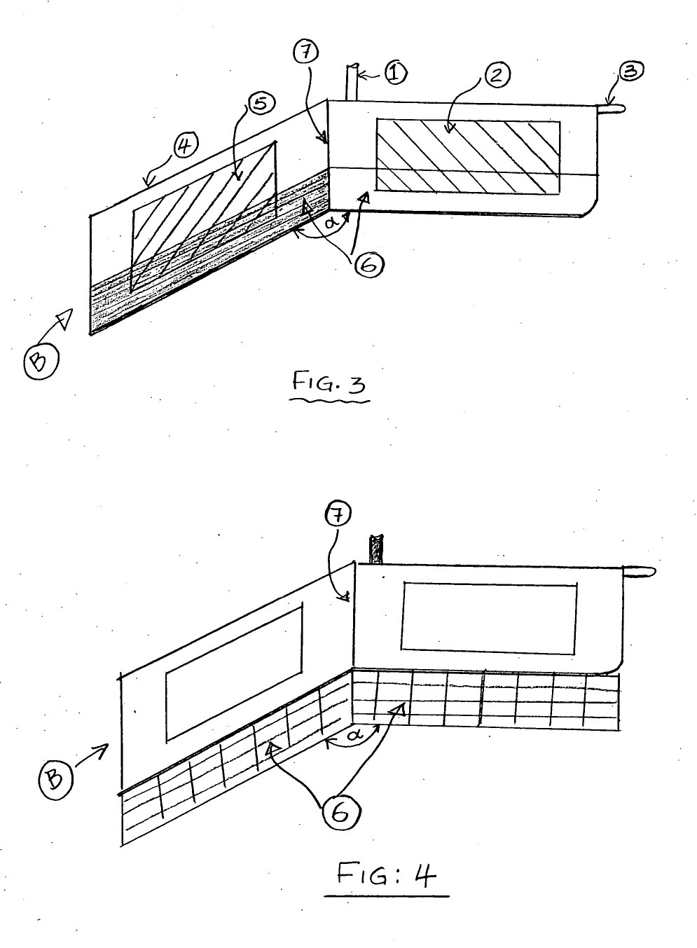

FIG. 3, is the expanded view of the components or segments of the split visor.

FIG. 4 is the expanded view of the components or segments with foldable extension

### DETAILED DESCRIPTION OF THE INVENTION

Exemplary embodiments are described with reference to specific configurations. Those of ordinary skill in the art will appreciate that a diversified applications and modifications can be made while remaining within the scope of this invention. In addition, well known methods, materials, process steps and the like may not be set forth in detail in order to avoid obscuring the invention.

The present invention is a split and/or folded safety visor for the vehicles where there is at least one driver and/or passenger is involved. Referring to the drawings wherein identical reference numerals denote the same elements throughout the various views. FIG. 1 illustrates the typical visor in a vehicle where the present invention is useful. Clearly, features of the discussion and claims are not limited to this particular application which is shown only for purpose of example. It will be readily apparent that the present invention may be applied to any kind of vehicle or any other moving object with at least one passenger. The visor A in FIG. 1 includes attachment rod 1 connected with the vehicle around which the visor rotate in different directions in different planes. The visor further includes vanity mirror and/or CD holder 2 which is attached with the visor with a cover. The visor also includes an extension 3 at the end—usually metallic which aids the visor to get attached with car top area when not in use.

FIG. 2 shows the present invention which shows the split visor B in folded form. The split visor B includes the cover 4 which remains closed when not in use. The cover 4 also can rotate from 0 to 180 degree or more (if necessary). In FIG. 2, the cover shown in the visor B in a closed form or 0 degree.

FIG. 3 shows the split visor B in the open position. The top cover 4 of the visor may rotate along the vertical axis 7 changing the angle α from 0 to 180 degree (or more if necessary). The top cover further may include vanity mirror and/or CD/DVD holder 5 or similar. The visor B further includes foldable extension 6 which also can be in closed or in open position as necessary. The foldable extension may have limited dimension only so that it doesn't warrant the safe driving. The foldable extension 6 may be made from opaque or non opaque material, semi transparent material or any net type material which doesn't block the light completely. The top cover 4 may have more extension in the split form in length wise which could be in closed or open position as required.

FIG. 4 shows the split visor B in completely open condition where foldable extension (vertically width wise) is also open. The foldable extension 6 may rotate from 0 degree (closed condition) to 180 degree (fully open or hanging condition) or more.

1. A vehicle using engines—gas, diesel, hybrid, gas turbine or similar which transport man and/or materials from one destination to others with at least one driver providing substantial safety containing split safety visors.

2. The vehicle of claim 1 wherein the visor is a split visor.

3. The vehicle of claim 1 wherein the visor is a multi split visor.

4. The vehicle in claim 1 wherein the split visor has one bottom part and one or more top covers.

5. The vehicle of claim 1 wherein the split visors are used for the driver side, passengers in rear and front of both sides and combinations thereof.

6. The vehicle in claim 1 wherein the top cover of the split visor can rotate from 0 to 180 degree around a vertical axis.

7. The vehicle in claim 1 wherein the top and bottom covers of the split visor contains foldable extensions.

8. The vehicle in claim 1 wherein the top and/or bottom cover contain vanity mirror, lights, cd, dvd holder and combinations thereof.

9. The vehicle in claim 1 wherein the foldable extensions are made from opaque, non opaque, semitransparent, net type material and combinations thereof.

10. A vehicle using engines—gas, diesel, hybrid, gas turbine or similar which transport man and/or materials from one destination to others with at least one driver providing standard safety visors containing clip on split visors.

11. The vehicle of claim 10 wherein the clip on visor is a split visor.

12. The vehicle of claim 10 wherein the clip on visor is a multi split visor.

13. the vehicle in claim 10 wherein the clip on split visor has one bottom part and one or more top covers.

14. The vehicle of claim 10 wherein the clip on split visors are used for the driver side, passengers in rear and front of both sides and combinations thereof.

15. The vehicle in claim 10 wherein the top cover of the clip on split visor can rotate from 0 to 180 degree around a vertical axis.

16. The vehicle in claim 10 wherein the top and bottom covers of the clip on split visor contains foldable extensions.

17. The vehicle in claim 10 wherein the top and/or bottom cover of the clip on visor contain vanity mirror, lights, cd, dvd holder and combinations thereof.

18. The vehicle in claim 10 wherein the foldable extensions of the clip on split visor are made from opaque, non opaque, semitransparent, net type material and combinations thereof.
